(19) United States
(12) Patent Application Publication
(10) Pub. No.: US 2026/0063500 A1
(43) Pub. Date: Mar. 5, 2026

(54) Method and Apparatus for Detecting a Defect of a Housing of a Controller

(71) Applicant: Robert Bosch GmbH, Stuttgart (DE)

(72) Inventors: Deivaraja Ramasamy, München (DE); Wadim Okley, Leinzell (DE)

(21) Appl. No.: 19/308,203

(22) Filed: Aug. 23, 2025

(30) Foreign Application Priority Data
Aug. 27, 2024 (DE) 10 2024 208 126.4

(51) Int. Cl. G01M 3/32

(52) U.S. Cl. CPC G01M 3/3245; G01M 3/3209

(57) ABSTRACT

An apparatus and method for detecting a defect, in particular a leakage, of a housing of a controller includes (i) capturing a first characteristic variable, which characterizes a humidity within the housing, (ii) determining a parameter depending on the first characteristic variable, wherein the parameter characterizes a dynamic of the humidity within the housing, and (iii) comparing the parameter with at least one predetermined threshold value or one predetermined range of validity, wherein a defect of the housing is detected if the parameter exceeds or falls below the at least one threshold value or the range of validity. A vehicle including a controller having a housing and the apparatus is also disclosed.

This application claims priority under 35 U.S.C. § 119 to application no. DE 10 2024 208 126.4, filed on Aug. 27, 2024 in Germany, the disclosure of which is incorporated herein by reference in its entirety.

### BACKGROUND

The present disclosure relates to a method and apparatus for detecting a defect, in particular a leakage, of a housing of a controller, and a vehicle comprising the apparatus.

Moisture sensors are used for various electronics in a vehicle to increase the application safety of the electronics. Direct limit values of relative humidity are useful for the detection of condensation. An evaluation of the relative humidity is performed locally at a location of the moisture sensor. As the homogeneity of a temperature within a housing of the electronics is not given, local condensation can occur, for example condensation on a heat sink, on which the temperatures are below the dew point. Accordingly, condensation water formation does not necessarily mean that the housing of electronics is damaged. The inhomogeneity of the temperature is not detected by the sensor and detection of a defect of the housing is unreliable.

Accordingly, it is desired to be able to reliably detect a defect, in particular a leakage, of a housing of a controller.

### SUMMARY

The object of the disclosure is achieved by way of an apparatus and a vehicle according to description set forth below.

The method for detecting a defect, in particular a leakage, of a housing of a controller provides for detecting a first characteristic value which characterizes a humidity within the housing; determining a parameter depending on the first characteristic value, wherein the parameter characterizes a dynamic of the humidity within the housing; and comparing the parameter with at least a predetermined threshold value or a predetermined range of validity, wherein a defect of the housing is detected if the parameter exceeds or falls below the at least one threshold value or the range of validity. By evaluating the dynamics of the humidity within the housing, a defect of the housing can be reliably detected. If the housing is defective, the humidity within the housing will adapt more quickly to changes in humidity outside the housing. The defect of the housing is thus reliably detected and an event can be triggered, which indicates to a user or a computing unit the existence of the defect. Application safety of the controller is thus safer, as damage to the electronics can be prevented, for example due to water penetrating through the defect.

Preferably, the parameter depicts a time change of the first characteristic variable and is in particular a time differential of the first characteristic variable. Thus, the dynamics of the humidity within the housing can be efficiently determined.

Preferably, relative humidity is used as the first characteristic variable. The first characteristic variable in the form of relative humidity may be provided inexpensively by way of a simple sensor. Many controllers already have a sensor that captures a signal that characterizes the relative humidity within the housing of the controller.

For example, the range of validity is defined by an upper limit value selected from a range between 10-15%/h. This upper limit value is based on tests by the inventor for a type of controller and characterizes a change of 10-15% relative humidity within one hour. A positive rate of change characterizes an increase in relative humidity within the housing and occurs when a relative humidity outside the housing is higher than the relative humidity within the housing. A negative rate of change characterizes a decrease in relative humidity within the housing and occurs when a relative humidity outside the housing is lower than the relative humidity within the housing.

An advantageous embodiment is characterized in that the method comprises capturing a second characteristic variable that characterizes humidity outside the housing and determining the parameter depending on the first characteristic variable and the second characteristic variable, wherein the parameter is a housing-specific time constant that characterizes a change in the first characteristic variable, in particular the humidity within the housing. The humidity outside the housing is not constant and changes with a movement of the controller, in particular when the controller is installed in a vehicle. The ambient air also has a cooling effect due to a movement of the controller. By way of the second characteristic variable, an influence of the humidity outside the housing is included in the determination of the parameter. As a result, the defect in the housing is reliably detected even if there is a slight difference between the humidity outside the housing and the humidity inside the housing.

Preferably, relative humidity is used as the first characteristic variable and the second characteristic variable. A signal characterizing relative humidity may be provided by way of inexpensive sensors.

Preferably, the defect of the housing is detected if the parameter falls below the at least one predetermined threshold value, wherein, for example, 7.0h or 6.9h is specified as the threshold value. This threshold value is based on tests by the inventor with a type of controller for a steer-by-wire steering system. Over time, a homogeneous equilibrium between the relative humidity inside and outside the housing occurs, similar to a gas exchange, heat exchange, or a charging or discharging of a capacitor. In case of a leakage as a defect, this equilibrium is achieved more quickly the greater the leakage is. The smaller the housing-specific time constant, the larger the leakage or defect of the housing.

The apparatus according to the disclosure for detecting a defect, in particular a leakage, of a housing of a controller, comprising a first sensor device, which is configured to capture a first characteristic variable which characterizes a humidity, in particular relative humidity, inside the housing of the controller; optionally a second sensor device, which is configured to capture a second characteristic variable which characterizes a humidity, in particular relative humidity, outside the housing of the controller; and a computing unit, which is configured to perform the method according to the above embodiment.

The vehicle according to the disclosure comprises a controller having a housing and the apparatus according to the above embodiment.

Preferably, the controller is a controller of a steer-by-wire steering system.

In a further aspect, a method for determining the at least one threshold value and/or the range of validity for the above-executed method is provided, comprising: providing a relative humidity within a space; providing a relative humidity within a chamber, wherein the chamber is provided in the space and the relative humidity within the chamber is higher than the relative humidity within the space; placing a controller of a test series within the space, wherein a dwell time of the controller in the space is selected in particular such that a value of a relative humidity within the housing of the controller has assumed at least 95% of a value of the relative humidity within the space; placing the controller from the space into the chamber, wherein a dwell time of the controller in the chamber is in particular selected such that a value of the relative humidity within the housing of the controller has assumed at least 78% of a relative humidity value within the chamber; placing the controller from the chamber into the space, wherein a dwell time of the controller in the room is selected in particular such that a value of the relative humidity within the housing of the controller has assumed at least 78% of a relative humidity value within the space; capturing the relative humidity within the space, the relative humidity within the chamber and the relative humidity within the housing of the controller; and determining at least one housing-specific time constant of the housing of the controller depending on the captured relative humidity within the space, the relative humidity within the chamber and the relative humidity within the housing of the controller. By way of this method, valid threshold values and/or ranges of validity for different types of controllers or housings of the control devices can be efficiently determined.

Preferably, the method comprises specifying the at least one threshold value and/or the range of validity for the above-mentioned method depending on the at least one determined housing-specific time constant of the controller's housing.

### BRIEF DESCRIPTION OF THE DRAWINGS

Further advantageous embodiments will become apparent from the following description and the drawing. The drawings show:

FIG. 1 a flow chart of a method for detecting a defect of a housing of a controller;

FIG. 2 a schematic diagram of an apparatus for detecting a defect of the housing of the controller;

FIG. 3 a section of a progression of relative humidity within the housing for different defects;

FIG. 4a a schematic illustration of a test setup;

FIG. 4b a flow chart of a test;

### DETAILED DESCRIPTION

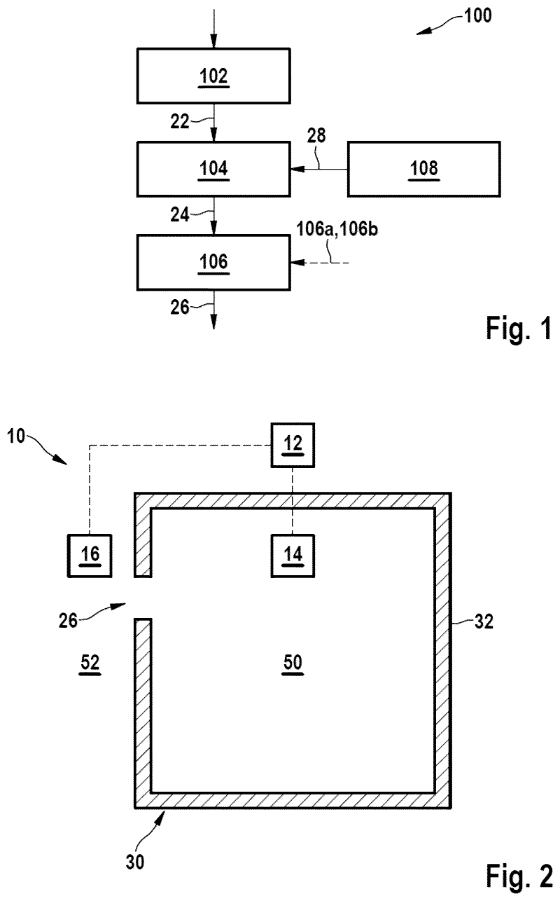

FIG. 1 shows a flow chart of a method 100 for detecting a defect 26, in particular a leakage, of a housing 32 of a controller 30, which is shown in FIG. 2. The method 100 comprises capturing 102 a first characteristic variable 22 which characterizes a humidity 50 within the housing 32 and determining 104 of a parameter 24 depending on the first characteristic value 22, wherein the parameter 24 characterizes a dynamics of the humidity 50 shown in FIG. 2 within the housing 32. In addition, the method 100 comprises comparing 106 the parameter 24 with at least one predetermined threshold value 106a or one predetermined range of validity 106b, wherein a defect 26 of the housing 32 is detected if the parameter 24 exceeds or falls below the at least one predetermined threshold value 106a or a range of validity 106b.

It may be contemplated that the method 100 further comprises triggering an event when a defect 26 of the housing 32 is detected. This event may be an indication to a user of a vehicle comprising the controller 30 and/or storing it in an error memory.

In a first embodiment of the method 100, it may be provided that the parameter 24 depicts a time change of the first characteristic variable 22 and in particular is a time differential of the first characteristic variable 22. This temporal differential is also hereinafter referred to as a gradient.

It may be contemplated that a relative humidity is used as the first characteristic variable 22. The equation

$${rH}_{i n} ( t + d t ) = {rH}_{i n} ( t ) + ( {rH}_{out} ( t ) - {rH}_{i n} ( t ) ) \cdot ( 1 - {e}^{- \frac{dt}{{τ}_{1}}} )$$

may be used as a model for changing the relative humidity 50 rHᵢₙ within the housing 32. rHᵢₙ(t) Wherein a provided or measured relative humidity 50 within the housing 32 and rHₒᵤₜ(t) a provided or measured or determined relative humidity 52 outside of the housing 32 at the time t, shown in FIG. 2. rHᵢₙ (t+dt) denotes a relative humidity 50 within housing 32 at a time t+dt, where dt is a time delta between two calculation steps, for example 0.1h. A housing-specific time constant is referred to as τ.

The time differential of the relative humidity 50 within the housing 32

$$\frac{{drH}_{i n}}{dt}$$

may be expressed as follows:

$$\frac{{drH}_{i n}}{dt} = \frac{{rH}_{out} - {rH}_{i n}}{{τ}_{1}} \cdot ( {e}^{- \frac{t}{τ}} ) .$$

In so doing, the relative humidity 52 outside the housing

$$r {H}_{out} ( t \to ∞ ) = r {H}_{in} + τ \cdot \frac{d r {H}_{i n}}{d t}$$

is assumed. For example, an allowable range of functions may be

$$\frac{d r {H}_{i n}}{d t} ∈ [ \frac{- r {H}_{i n}}{τ} ; \frac{100 \% - {rH}_{i n}}{τ} ]$$

expressed.

Controllers 30 typically have a pressure compensating valve, ports, and/or seals, thereby allowing for an exchange of humidity. It may be that an exchange of humidity is different depending on one direction of exchange. This may be exemplified by the context

$$r {H}_{o u t} > r {H}_{i n} OR \frac{d r {H}_{i n}}{d t} > 0 \to τ is larger$$

$${rH}_{o u t} < r {H}_{i n} OR \frac{d r {H}_{i n}}{d t} < 0 \to τ is smaller$$

This means that if the relative humidity 50 within the housing 32 is higher than the relative humidity 52 outside of the housing 32, equilibrium is reached more quickly than vice versa. This is characterized by the various housing-specific time constants t. This difference in the housing-specific time constants depending on an exchange direction of the relative humidities 50 and 52 can be taken into account, for example, by way of two different threshold values 106a. It may be contemplated that a first threshold value 106a is used when the relative humidity 50 within the housing 32 is lower than the relative humidity 52 outside the housing 32 and that a second threshold value 106a is used when the relative humidity 50 within the housing 32 is higher than the relative humidity 52 outside the housing 32.

Sensors are typically used to measure the relative humidity 50 within the housing. For example, these have a range between 10%-90% relative humidity. Also, if a time constant τ:=3.5h is assumed for a positive gradient

$$\frac{d r {H}_{i n}}{dt} ,$$

and a time constant τ:=3, h is assumed as a minimum measure for a negative gradient

$$\frac{d r {H}_{i n}}{dt} ,$$

then the allowable range of functions may be illustrated according to the above definition

$$r {H}_{i n} ∈ [ 10 \% ; 90 \% ]$$

$$\frac{d r {H}_{i n}}{d t} ∈ [ - 30 \frac{\%}{h} ; 26 \frac{\%}{h} ]$$

The gradient

$$\frac{d r {H}_{i n}}{dt}$$

represents the parameter 24 in the first embodiment. This is determined continuously and compared 106 to the range of validity 106b. The range of validity 106b can map the above-mentioned limits of the permitted range of functions or be applied to corresponding control devices by way of tests. If the comparison 106 shows that the parameter 24 is outside the range of validity 106b, there is a high probability that the housing 32 of the controller 30 has a defect 26.

In the first embodiment, only a first sensor device 14 is needed, shown in FIG. 2, which captures the first characteristic variable 22, for example as a signal characterizing the relative humidity 50 within the housing 32. This sensor device 14 is already present in many controllers, which can save costs. As a gradient is used in this embodiment of the method 100, offsets and drifts have no impact on the method 100. However, a dynamic of the relative humidity 52 outside of the housing 32 is not considered, sometimes requiring high differences between the relative humidity 50 inside and the relative humidity 52 outside of the housing 32 to reliably detect the failure 26.

In a second embodiment of the method 100, capturing 108 a second characteristic variable 28 that characterizes a humidity 52 outside of the housing 32 and determining 106 the parameter 24 depending on the first characteristic variable 22 and the second characteristic 28 is provided, wherein the parameter is the housing-specific time constant τ that characterizes a change in the humidity 50 within the housing 32.

It may be contemplated that a relative humidity is used as the first characteristic variable 22 and the second characteristic variable 28. In the example, the first characteristic variable 22 is the relative humidity 50 within the housing 32 and the second characteristic variable 28 is the relative humidity 52 outside the housing 32 of the controller 30.

In the second embodiment, the following model for the relative humidity 50 within the housing 32 may be used:

$$r {H}_{i n} ( t + d t ) = r {H}_{in} ( t ) + ( r {H}_{out , avg} ( t , t + d t ) - r {H}_{in} ( t ) ) \cdot ( 1 - {e}^{- \frac{d t}{{τ}_{1}}} ) .$$

Here, rH_{out,avg}(t,t+dt) is an average relative humidity 52 outside the housing 32 over a time range of t to t+dt. The housing-specific time constant τ is dependent on a defect, for example a size of the leakage. The housing-specific time constant τ may be determined as follows:

$$τ = dt \cdot ln ( \frac{r {H}_{out , avg} ( t , t + dt ) - r {H}_{i n} ( t )}{r {H}_{i n} ( t + dt ) - r {H}_{i n} ( t )} ) .$$

The second characteristic 28 in the example is a signal that characterizes the relative humidity 52 outside of the housing 32 and provided 108 by a second sensor device 16, shown in FIG. 2. In the second embodiment, the housing-specific time constant τ is continuously determined as the parameter 24. This is different for different controller types or housing types and also changes if there is a defect 26 on the housing 32. The larger the defect 26, for example a leakage, the smaller the housing-specific time constant τ, as an equilibrium between the humidities within and outside of the housing 32 is established more quickly.

The second sensor device 16 is typically exposed to the elements and therefore an offset drift correction and/or a heating element can be used on the second sensor device 16, so that the second sensor device 16 can operate in the working range of, for example, 10% to 90% relative humidity.

In the second embodiment, a defect 26 of the housing 32 is detected when the parameter 24, i.e., the housing-specific time constant τ, falls below the at least one predetermined threshold value 106a, for example a τ_{threshold}. This may be expressed when comparing 106 as follows:

$$τ < {τ}_{threshold} .$$

It may be contemplated that two predetermined thresholds values 106a may be considered depending on whether the relative humidity 50 within the housing 32 is higher than the relative humidity 52 outside the housing 32 of the controller 30. Accordingly, depending on the first characteristic variable 22 and the second characteristic variable 28, it can be determined which threshold value 106a of the at least one predetermined threshold value 106a is used to compare 106 and detect the defect 26. As described above, the housing-specific time constant τ for an exchange of humidity for an increase and a decrease of the relative humidity 50 within the housing 32 of controller 31 may be different. The relative humidity 50 within the housing 32 increases when the relative humidity 52 outside the housing 32 is higher than the relative humidity 50 within the housing 32. The relative humidity 50 within the housing 32 decreases when the relative humidity 52 outside the housing 32 is lower than the relative humidity 50 within the housing 32.

FIG. 2 shows an apparatus 10 for detecting a defect 26, in particular a leakage, of a housing 32 of a controller 30, in a schematic diagram. The apparatus 10 comprises the first sensor device 14 for capturing humidity 50 within a housing 32 of controller 30, and optionally, for example in the case of use of the further embodiment of method 100, a second sensor device 16 for capturing humidity 52 outside of the housing 32. In addition, the device 10 comprises a computing unit 12, which is configured to perform the method 100. It may be contemplated that the computing unit 12 is configured to perform the first and the second embodiments of the method 100 in parallel in order to make the method 100 more reliable, in that the parameter 24 comprises the time differential

$$\frac{d r {H}_{i n}}{dt}$$

and the determined housing-specific time constant τ and the method 100 takes this into account when comparing 106 in each case. It is also conceivable that the computing unit 12 is configured to perform the first and the second embodiment of the method 100 redundantly, for example in the event that the second sensor device 16 fails.

In addition, FIG. 2 shows a defect 26 of the housing 32 of the controller 30, which is shown as a leakage, through which an equilibrium of the humidity 50 inside the housing 32 and the humidity 52 outside the housing 32 is reached more quickly compared to an undamaged housing or a smaller defect 26.

The computing unit 12 may be formed by the controller 30 or by a further controller. The controller 30 is in particular configured as a controller for a steer-by-wire steering device.

For example, the threshold value 106a and/or the range of validity 106b may be determined by test series of controllers 30 of the same type. It is advantageous if the test series comprises a plurality of controllers 30, the housing 32 having a defect 26 of different configurations. It is advantageous if at least one controller 30 does not comprise a defective housing 32 so that a suitable reference value can be determined.

A controller 30 from the test series can be placed in a test chamber, by way of which a positive or negative jump of a humidity to a pre-determinable target value is realized. When performing the test series, the relative humidity 50 within the housing 32 and the relative humidity 52 outside the housing 32 are continuously captured and recorded. This can be done, for example, by way of the first and second sensor devices 14 and 16 or by way of sensors of the test chamber. For each controller of the test series, case-specific time constants τᵢ may be determined using the models described above and the recorded relative humidity, more simply referred to as measurement data, wherein the index i characterizes a particular test series controller. It should be noted that the test chamber also has a time constant τ_{chamber}, since the jump is not ideal, which can be compensated for from the recorded measurement data. This can be implemented using the equation

$${τ}_{i} = \sqrt{{τ}_{o v e r a l l}^{2} - {τ}_{c h a m b e r}^{2}}$$

Here, τₒᵥₑᵣₐₗₗ corresponds to the time constant determined from the measurement data by way of the models described above. For example, based on tests with a controller for a steer-by-wire steering device and a positive jump of the relative humidity 52 outside of the housing 32, a time constant of the test chamber of τ_{chamber}=1.2h results.

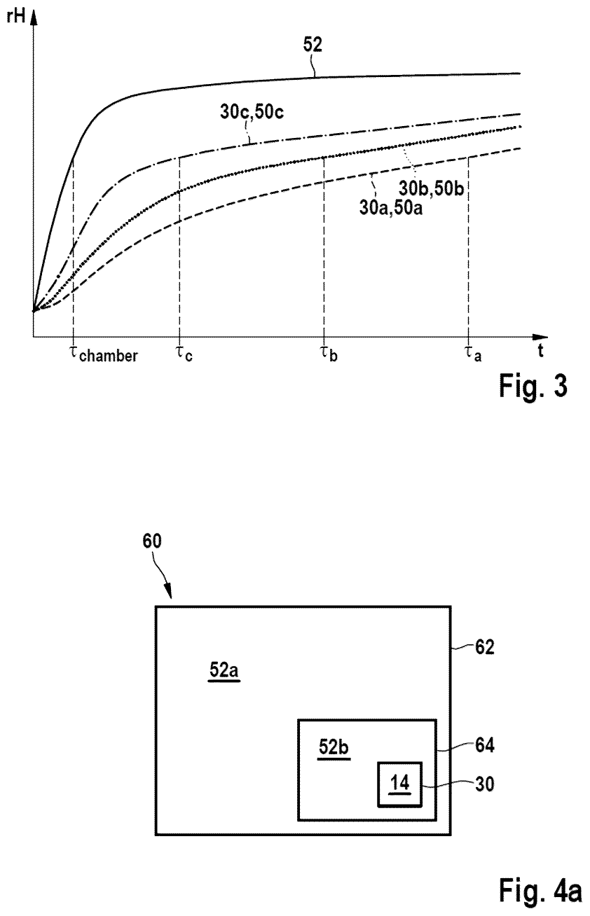

FIG. 3 shows a progression of a humidity rH of an exemplary test series over time t. The test series comprises a first controller 30a having a housing 32 that is not damaged and has no defect 26, a second controller 30b having a housing 32 that has a through-hole of 1 mm diameter, and a third controller 30c having a housing 32 that has a through-hole of 2 mm diameter. These through-holes are a defect 26 in the form of a leakage. However, apart from the through-holes, controllers 30a to 30c are identically configured and controllers of a steer-by-wire steering device.

FIG. 3 also shows a progression of the relative humidity 52 outside of the housing 32 generated by the test chamber. By way of the test chamber, a positive jump of the relative humidity 52 outside the housing 32 of the controller 30 is depicted in the example. The dashed line shows a progression of relative humidity 52a within the housing 32 of controller 30a. The dotted line shows a progression of a relative humidity 52b within the housing 32 of controller 30b. The dash-dot line shows a progression of a relative humidity 52c within the housing 32 of the controller 30c. For all controllers 30a, 30b and 30c of the test series, corresponding housing-specific time constants τₐ, τ_{b}, and τ_{c} can be determined from the recorded measurement data. For example, corresponding tests by the inventors resulted in a housing-specific time constant of τₐ=6.9h for the non-defective controller 30b, a housing-specific time constant of τ_{b}=5.8h for controller 30c with a 1 mm through-hole, and a housing-specific time constant of τ_{c}=4.65h for the controller 30c with a 2 mm through-hole. Based on these findings obtained from the test series, a threshold value 106a for the parameter 24 in the form of a housing-specific time constant of τ_{threshold}≈6.9h can be selected. A fault tolerance of the threshold value 106a can be determined by way of further test series and taken into account accordingly.

Based on the exemplary test series depicting a positive jump or increase in relative humidity 52 outside of housing 32, an upper limit for the range of validity 106b may also be determined in the event that parameter 24 is a time differential of relative humidity 50 within housing 32 in the form of the gradient

$$\frac{d r {H}_{i n}}{dt} .$$

The upper limit value is determined according to the above equation.

$$\frac{100 \% - 10 \%}{6.9 h} = 13.04 \frac{\%}{h} .$$

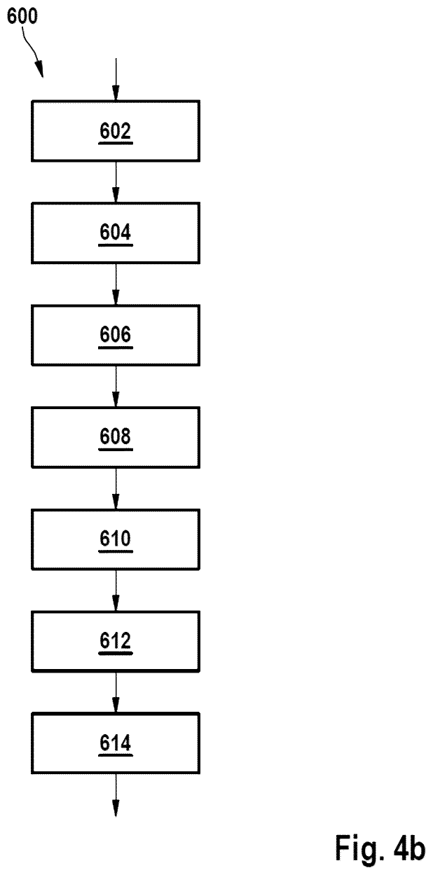

FIG. 4a shows a test setup 60 of a test by way of which the threshold value 106a and/or the upper limit value and a lower limit value of the range of validity 106b can be determined. The test setup 60 comprises a space 62 in which a relative humidity is controlled and has, for example, a target value of 30% relative humidity. The space 62 comprises a chamber 64 that has a humidity that is higher than that of the space 62, for example 70% relative humidity. By way of method 60, it is possible to reproduce a positive and negative jump in the relative humidity 52 outside of the housing 32 almost ideally.

FIG. 4b shows a flow chart of a method 600 for determining the threshold value 106a and/or the range of validity 106b for the method 100 for determining a defect 26 of the housing 32 of controller 30. In a step 602, a pre-determinable relative humidity 52a is provided within the space 62 by way of the space 62. In a step 604, a pre-determinable relative humidity 52b within the chamber 64 is provided by the chamber 64, wherein the pre-determinable relative humidity 52a within the chamber 64 is higher than the pre-determinable relative humidity 52b within the space 62.

In a step 606, the at least one controller 30 of a test series is placed in the space 62. A dwell time in the space 62 of the controller 30 placed in the space 62 may be selected such that a value of relative humidity 50 within the housing 32 of the controller 30 has assumed at least 95% of a value of relative humidity 52a within the space 62. In particular, the placed controller 30 may have at least a dwell time of approximately three times the housing-specific time constant t if a non-defective controller 30 in the space 62, so that a sufficient equilibrium between the relative humidity 52a of the space 62 outside of the housing 32 and the relative humidity 50 within the housing 32 is established. This dwell time is, for example, about 20 to 24h.

In a step 608 following step 606, controller 30 is placed into the chamber 64. A dwell time in the chamber 64 of the controller 30 placed in the chamber 64 may be selected such that a value of relative humidity 50 within housing 32 of controller 30 has assumed at least 78% of a value of relative humidity 52b within the chamber 64. A dwell time of the controller 30 in the chamber 64 may correspond to approximately one and a half times the housing-specific time constant τ of a non-defective controller 30. This dwell time is, for example, 8 to 10h. This shows a positive jump in the relative humidity 52 outside of the housing 32. The relative humidity 50 within the housing 32 of the controller 30 increases.

In a step 610 following step 608, the controller 30 is placed from chamber 64 into space 62. A dwell time in the space 62 of the controller 30 placed in the space 62 may be selected such that a value of relative humidity 50 within the housing 32 of the controller 30 has assumed at least 78% of a value of relative humidity 52a within the space 62. A dwell time of the controller 30 in the space 62 may correspond to approximately at least one and a half times the housing-specific time constant τ of a non-defective controller 30. This dwell time is, for example, 8 to 10h. This shows a negative jump in the relative humidity 52 outside of the housing 32. The relative humidity 50 within the housing 32 of the controller 30 decreases.

The method 600 also comprises, in particular continuous, capturing 612 of the relative humidity 52a and 52b outside of the housing 32 and the relative humidity 50 within the housing 32, in particular during steps 602-610. This can be implemented, for example, by way of the first and second sensor devices 14 and 16 or by way of sensors of the chamber 62 or the space 64.

In a step 612, a housing-specific time constant τ_{i,1} for an increase in the relative humidity 50 within the housing 32 and a housing-specific time constant τ_{i,2} for a decrease in the relative humidity 50 within the housing 32 are determined for each controller 30 of the test series based on recorded measurement data in the form of the relative humidity 52a and 52b outside the housing 32 and the relative humidity 50 within the housing 32, for example using the above-mentioned models. For the determination, statistical methods, for example a Gaussian normal distribution and a mean determination, may be helpful in taking into account a standard deviation in the form of μ+3σ to map error tolerances of the controller.

For example, the upper and lower limit values of the range of validity 106b may be defined in consideration of the above models as follows:

$$r {H}_{i n} ∈ ( 10 \% ; 90 \% )$$

$$\frac{d r {H}_{i n}}{d t} ∈ ( \frac{- r {H}_{i n}}{τ} , \frac{100 \% - {rH}_{i n}}{τ} )$$

$$\frac{d r {H}_{i n}}{dt} ∈ ( \frac{- 90 \%}{{τ}_{i , 2}} , \frac{100 \% - 10 \%}{{τ}_{i , 1}} ) .$$

For example, the at least one threshold value 106a may be determined from measurement data of an undamaged or damaged controller 30 or from a test series consisting of a plurality of undamaged or a mixture of damaged and undamaged controllers 30. The housing-specific time constants τ_{i,1}, τ_{i,2} determined in step 614 can be used with or without consideration of a tolerance as the basis for specifying the threshold values 106a or the threshold value 106a.

What is claimed is:

1. A method for detecting a defect of a housing of a controller, comprising:
capturing a first characteristic variable characterizing a humidity within the housing;
determining a parameter depending on the first characteristic variable, wherein the parameter characterizes a dynamic of the humidity within the housing; and
comparing the parameter with at least one predetermined threshold value or one predetermined range of validity, wherein the defect of the housing is detected if the parameter exceeds or falls below the at least one threshold value or the range of validity.

2. The method according to claim 1, wherein the parameter depicts a time change of the first characteristic variable and is a time differential of the first characteristic variable.

3. The method according to claim 2, wherein a relative humidity is used as the first characteristic variable.

4. The method according to claim 1, further comprising:
capturing a second characteristic variable that characterizes a humidity outside the housing; and
determining the parameter depending on the first characteristic variable and the second characteristic variable, wherein the parameter is a housing-specific time constant that characterizes a change of the first characteristic variable.

5. The method according to claim 4, wherein a relative humidity is used as the first characteristic variable and the second characteristic variable.

6. The method according to claim 5, wherein the defect of the housing is detected when the parameter falls below the at least one predetermined threshold value.

7. An apparatus for detecting a defect of a housing of a controller, comprising:
a first sensor device which is configured to capture a first characteristic variable which characterizes a humidity inside the housing of the controller; and
a computing unit which is configured to perform the method according to claim 1.

8. A vehicle, comprising:
a controller having a housing; and
the apparatus according to claim 7.

9. A method for determining the at least one threshold value and/or the range of validity for the method according to claim 1, comprising:
providing a relative humidity within a space;
providing a relative humidity within a chamber, wherein the chamber is provided in the space and the relative humidity within the chamber is higher than the relative humidity within the space;
placing a controller of a test series within the space, wherein a dwell time of the controller in the space is selected such that a value of relative humidity within the housing of the controller has assumed at least 95% of a value of the relative humidity within the space;
placing the controller from the space into the chamber, wherein a dwell time of the controller in the chamber is selected such that a value of the relative humidity within the housing of the controller has assumed at least 78% of a relative humidity value within the chamber;
placing the controller from the chamber into the space, wherein a dwell time of the controller in the space is selected such that a value of a relative humidity within the housing of the controller has assumed at least 78% of a relative humidity value within the space;
capturing the relative humidity within the space, the relative humidity within the chamber, and the relative humidity within the housing of the controller; and
determining at least one housing-specific time constant of the housing of the controller depending on the captured relative humidity within the space, the relative humidity within the chamber and the relative humidity within the housing of the controller.

10. The method according to claim 9, further comprising specifying the at least one threshold value and/or the range of validity for the method depending on the at least one determined housing-specific time constant of the housing of the controller.

11. The method according to claim 1, wherein the defect is a leakage.

12. The apparatus according to claim 7, wherein the defect is a leakage.

13. The apparatus according to claim 7, wherein the humidity inside the housing of the controller is a relative humidity inside the housing of the controller.

14. The apparatus according to claim 7, further comprising a second sensor device which is configured to capture a second characteristic variable which characterizes a humidity outside the housing of the controller.

15. The apparatus according to claim 14, wherein:
the humidity inside the housing of the controller is a relative humidity inside the housing of the controller, and
the humidity outside the housing of the controller is a relative humidity outside the housing of the controller.
